(19) United States
(12) Patent Application Publication
(10) Pub. No.: US 2004/0144804 A1
(43) Pub. Date: Jul. 29, 2004

(54) Cleaning material dispenser for caulking guns

(76) Inventor: Wayne J. Borisch, Pompano Beach, FL (US)

Correspondence Address: Donald J. Ersler, 725 Garvens Avenue, Brookfield, WI, 53005, US

(21) Appl. No.: 10/752,354

(22) Filed: Jan. 5, 2004

Related U.S. Application Data
(60) Provisional application No. 60/440,975, filed on Jan. 17, 2003.

(51) Int. Cl. B67D 1/08

(52) U.S. Cl. 222/148

(57) ABSTRACT

A cleaning material dispenser includes a retention tube, a tube support end cap, a cover end cap and a material roll. The tube support end cap is attached to one end of the retention tube and the cover end cap is attachable to the other end thereof. A material slot is formed through the retention tube to receive an end of the material roll. In a second and third embodiment, a container base and a container end cap are used to retain the material roll. In a fourth embodiment, a dispenser is used to retain a plurality of sheets. The cleaning material dispensers may be attached to a user's clothing with an attachment clip. The cleaning material dispensers may be attached to a caulking gun with an attachment device. The cleaning material dispenser may also be formed as an integral part of a caulking gun.

### CROSS-REFERENCES TO RELATED APPLICATIONS

This is a utility patent application, taking priority from provisional patent application, serial No. 60/440,975 filed on Jan. 17, 2003.

### BACKGROUND OF THE INVENTION

1. Field of the Invention

The present invention relates generally to caulking guns and more specifically to a cleaning material dispenser for caulking guns, which enables a user of the caulking gun to wipe excess caulk off a dispensing tip of a caulking tube.

2. Discussion of the Prior Art

It appears that the prior art does not disclose a cleaning material dispenser for caulking guns. The application of caulk is a very common activity for painters, builders and other tradepersons. However, it appears that an efficient method of dispensing an exact amount of caulk has not been developed. As a result, a tradeperson applying caulk must always wipe excess caulk from a dispensing tip of a caulking tube. Typically, tradepersons use a cloth for cleaning the dispensing tip of the caulking tube. However, the cloth will quickly become loaded with excess caulk.

Accordingly, there is a clearly felt need in the art for a cleaning material dispenser for caulking guns, which may be attachable to a belt, attachable to a caulking gun, or fabricated as an integral part of a caulking gun.

### SUMMARY OF THE INVENTION

The present invention provides a cleaning material dispenser for caulking guns, which is used to wipe excess caulk from a dispensing tip of a caulking gun. The cleaning material dispenser includes a retention tube, a tube support end cap, a cover end cap and a material roll. The tube support end cap preferably includes a tube end cap and a material tube. The material tube extends from a center of the tube end cap. The material roll is typically wound on a spindle tube. The material tube is sized to be inserted into the spindle tube. The tube support end cap is attached to one end of the retention tube and the cover end cap is removably attachable to the other end of the retention tube. An inner perimeter of the retention tube is sized to receive an outer diameter of the material roll. A material slot is formed through a wall of the retention tube to receive an end of the material roll. A dispenser support is preferably attached adjacent to the material slot. A serrated edge is preferably formed on an end of the dispenser support to allow a piece of material to be severed from the material roll. A pressure lip is preferably attached to the retention tube, such that an end of the pressure lip forces an end of the material roll against the dispenser support.

The cleaning material dispenser may be attached to the user by securing one side of an attachment clip to the retention tube. The attachment clip may be slipped over a belt, pants, a shirt or any other appropriate area of clothing. The cleaning material dispenser may be attached to a caulking gun with a clamp assembly. The clamp assembly preferably includes a U-shaped bracket and a clamping bolt. One side of the U-shaped bracket is secured to the cleaning material dispenser. The U-shaped bracket may be placed over some part of a caulking gun and the clamping bolt is tightened until the clamp assembly is secured to the caulking gun.

The cleaning material dispenser may also be attached to a caulking gun with an attachment bracket. One end of the attachment bracket is secured to the cleaning material dispenser and a bolt hole is formed through the other end of the attachment bracket. A bolt is inserted through the bolt hole and a slot in some part of a caulking gun. The other end of the attachment bracket is secured to the caulking gun by tightening a nut on the bolt. However, other types of brackets or fastening methods may be used to attach the cleaning material dispenser to the caulking gun. The cleaning material dispenser may also be formed as an integral portion of some part of a caulking gun.

A second embodiment of a cleaning material dispenser includes a container base, container end cap, and a material roll. An attachment device extends from a bottom of the container base. The attachment device allows the cleaning material dispenser to be secured to the caulking gun. An inner perimeter of the container base is sized to receive an outer perimeter of the material roll. A material spindle preferably extends from a bottom of an inside of the container base. The material spindle is sized to be received by a spindle tube of the material roll. An outer perimeter of the container base is sized to removably receive an inner perimeter of the container end cap. A material slot is formed through a wall of the container base to receive an end of the material roll. A dispenser support is preferably attached adjacent to the material slot. A shear edge is preferably formed on an end of the dispenser support to allow a piece of material to be severed from the material roll.

A third embodiment of the cleaning material dispenser includes all the elements of the second embodiment and a container end cap that locks to the container base. A spring loaded projection is formed on a wall of the container base and a projection opening is formed in a wall of the container end cap to receive a projection of the spring loaded projection.

A fourth embodiment of the cleaning material dispenser includes a material container, a container lid and a quantity of cleaning material. The material container is sized to receive the container lid. A material slot is formed through a top of the container lid to receive an end of the quantity of cleaning material. The quantity of cleaning material is preferably in the form of a plurality of individual sheets that are connected to each other, such that when a first sheet is pulled out of the material container, a second sheet replaces thereof in the material slot. An attachment device preferably extends from a bottom of the material container for attachment to a top of a trigger assembly of a caulking gun.

Accordingly, it is an object of the present invention to provide a cleaning material dispenser for caulking guns, which includes an attachment clip that may be secured to clothing.

It is a further object of the present invention to provide provide a cleaning material dispenser for caulking guns, which includes an attachment device that may be secured to a caulking gun.

It is yet a further object of the present invention to provide a cleaning material dispenser for caulking guns, which may be formed as an integral portion of a caulking gun.

Finally, it is another object of the present invention to provide a cleaning material dispenser, which includes a plurality of cleaning material in the form of individual sheets.

These and additional objects, advantages, features and benefits of the present invention will become apparent from the following specification.

### BRIEF DESCRIPTION OF THE DRAWINGS

FIG. 1 is an exploded perspective view of a cleaning material dispenser for caulking guns in accordance with the present invention.

FIG. 2 is a perspective view of a cleaning material dispenser for caulking guns in accordance with the present invention.

FIG. 3 is an end view of a cleaning material dispenser for caulking guns with a tube support end cap removed in accordance with the present invention.

FIG. 4 is an end view of a cleaning material dispenser for caulking guns with an attachment clip in accordance with the present invention.

FIG. 5 is a top view of a cleaning material dispenser secured to a caulking gun in accordance with the present invention.

FIG. 6 is an end view of a cleaning material dispenser with an attachment bracket secured to a caulking gun in accordance with the present invention.

FIG. 7 is a side view of a caulking gun having an integral cleaning material dispenser in accordance with the present invention.

FIG. 8 is a partially exploded perspective view of a second embodiment of a cleaning material dispenser for caulking guns in accordance with the present invention.

FIG. 9 is a partially exploded perspective view of a third embodiment of a cleaning material dispenser for caulking guns in accordance with the present invention.

FIG. 9a is a perspective view of a material roll with a plurality of periodic separation cut lines of a first, second or third embodiment for a cleaning material dispenser for caulking guns in accordance with the present invention.

FIG. 10 is an end cross sectional view of a second embodiment of a cleaning material dispenser for caulking guns cut through FIG. 8 in accordance with the present invention.

FIG. 11 is an enlarged end cross sectional view of a third embodiment of a cleaning material dispenser for caulking guns cut through FIG. 9 in accordance with the present invention.

FIG. 12 is a side cross sectional view of a second or third embodiment of a cleaning material dispenser for caulking guns cut through FIG. 8 or 9 and attached to a trigger assembly of a caulking gun with a single top projection in accordance with the present invention.

FIG. 13 is a side cross sectional view of a second or third embodiment of a cleaning material dispenser for caulking guns cut through FIG. 8 or 9 and attached to a trigger assembly of a caulking gun with a hollow top projection in accordance with the present invention.

FIG. 14 is a side cross sectional view of a fourth embodiment of a cleaning material dispenser for caulking guns attached to a caulking gun in accordance with the present invention.

FIG. 15 is a top view of a fourth embodiment of a cleaning material dispenser for caulking guns in accordance with the present invention.

### DETAILED DESCRIPTION OF THE PREFERRED EMBODIMENTS

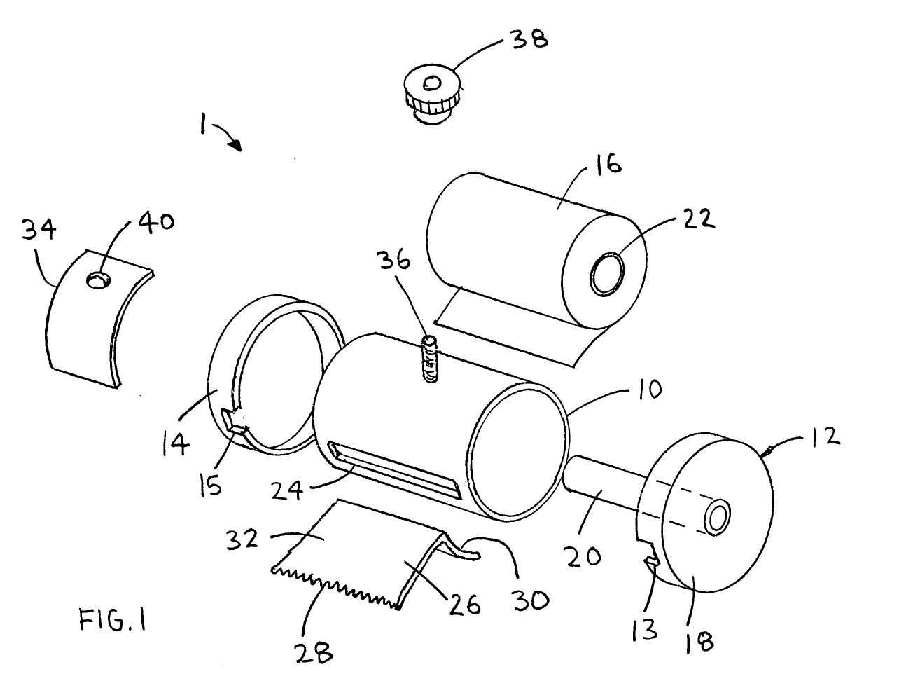

With reference now to the drawings, and particularly to FIG. 1, there is shown an exploded perspective view of a cleaning material dispenser for caulking guns (cleaning material dispenser) 1. The cleaning material dispenser 1 includes a retention tube 10, a tube support end cap 12, a cover end cap 14, and a material roll 16. The tube support end cap 12 preferably includes a tube end cap 18 and a material tube 20. The material tube 20 is attached to a center of the tube end cap 20 with any suitable fastening method. The material roll 16 is typically wound on a spindle tube 22. The material roll 16 is preferably a roll of paper used in an adding machine, but other materials may also be used. The material tube 20 is sized to be inserted into the spindle tube 22.

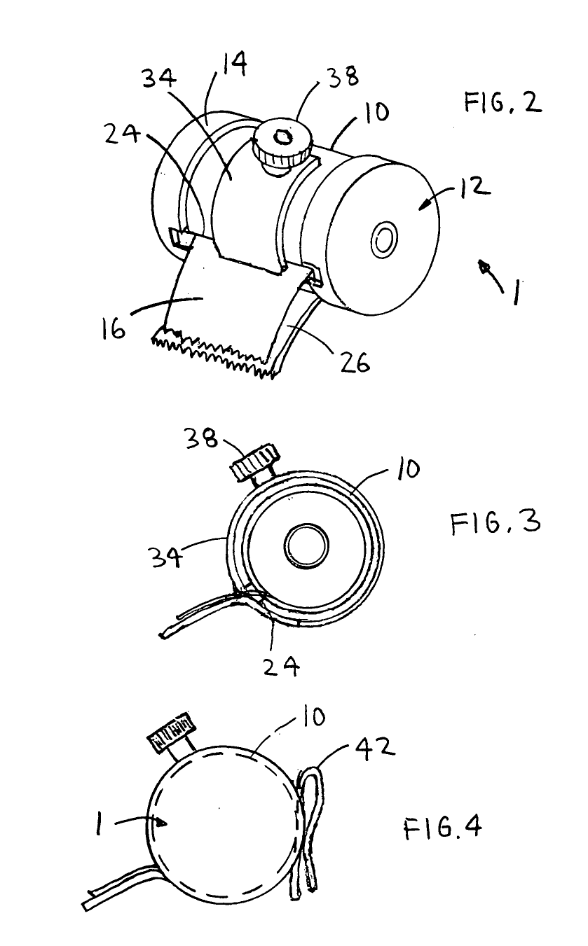

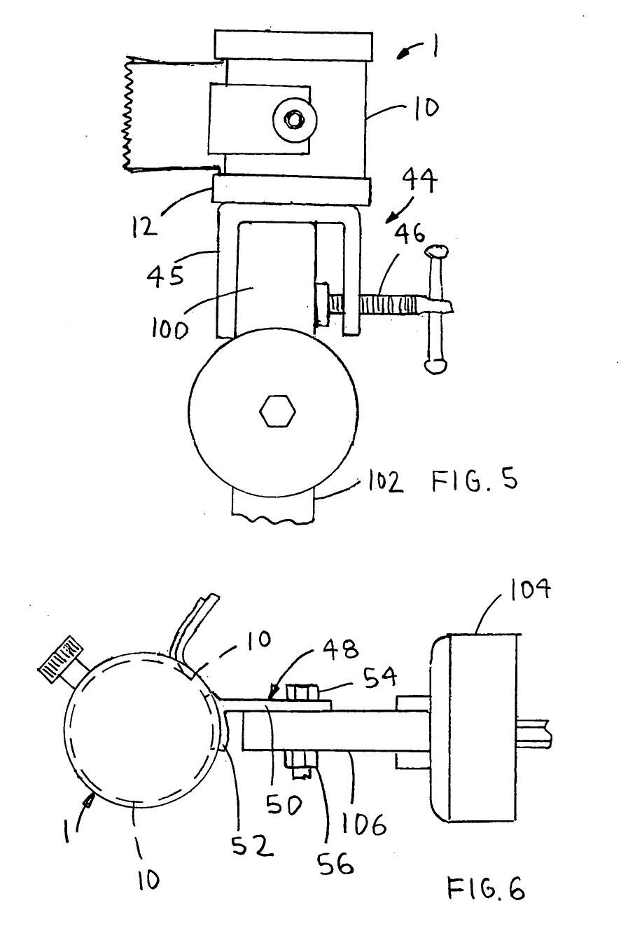

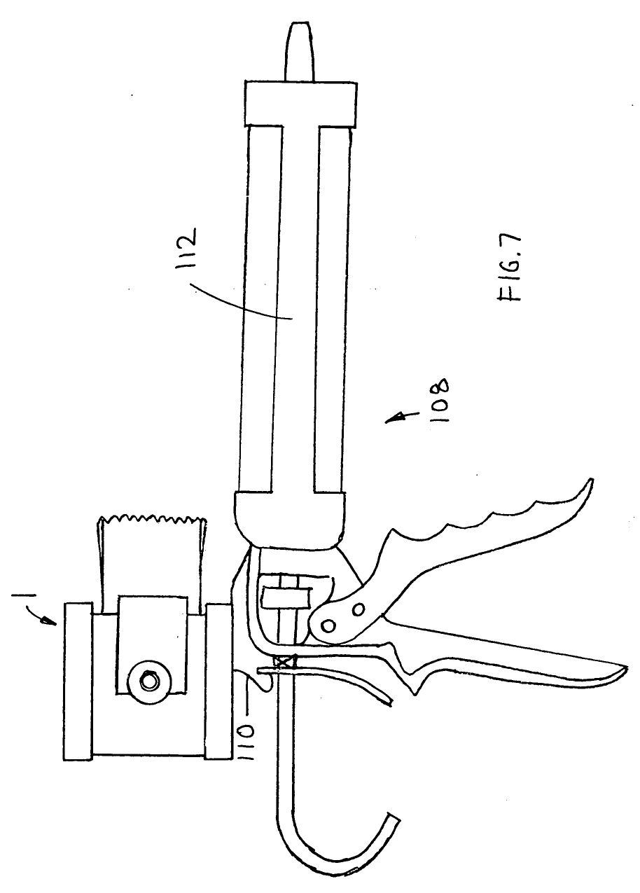

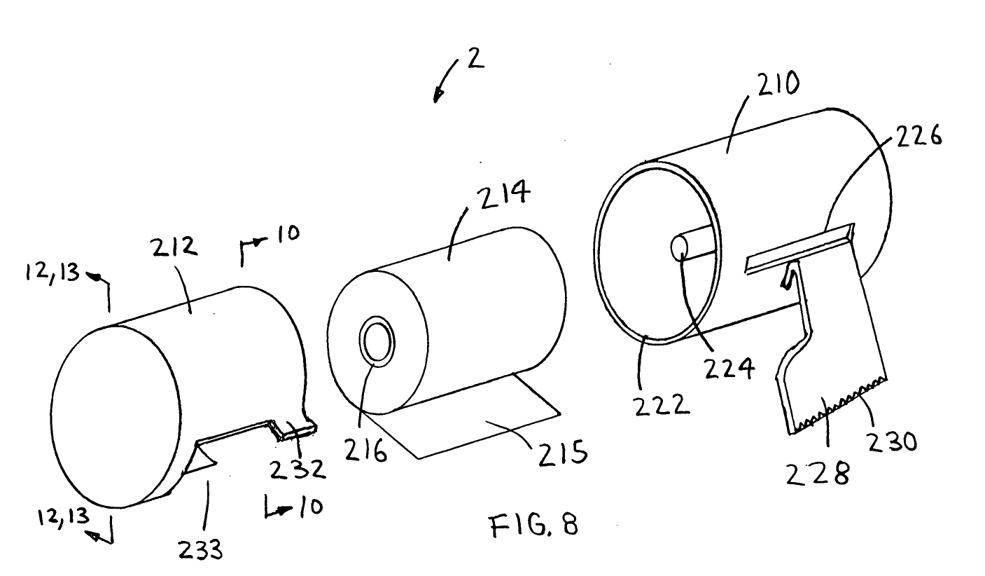

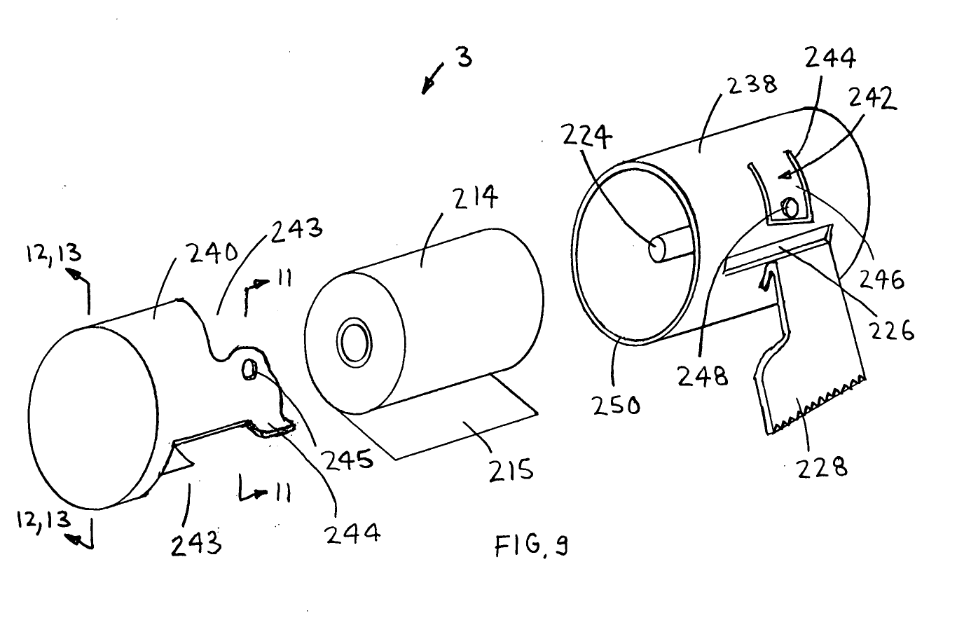

The tube support end cap 12 is attached to one end of the retention tube 10 and the cover end cap 14 is removably attachable to the other end of the retention tube 10. An inner perimeter of the retention tube 10 is sized to receive an outer diameter of the material roll 16. With reference to FIGS. 2 and 3, a material slot 24 is formed through a wall of the retention tube 10. The material slot 24 is sized to receive a width of the material roll 16. The retention tube 10 is preferably fabricated from a clear or translucent plastic to allow the remaining amount of material roll 16 to be observed. However, the retention tube 10 may be fabricated from other materials. A clearance slot 13 is preferably formed in a perimeter of the tube support end cap 12 and a clearance slot 15 is preferably formed in a perimeter of the cover end cap 14.

A dispenser support 26 is attached to the retention tube 10, adjacent the material slot 24. A serrated edge 28 is preferably formed on an end of the dispenser support 26 to allow a piece of material to be severed from the material roll 16. An attachment leg 30 extends from a support surface 32. The attachment leg 30 is preferably curved to receive an outer perimeter of the retention tube 10. The attachment leg 30 is attached to the retention tube 10 with any suitable fastening method. A pressure lip 34 is preferably attached to the retention tube 10 with a stud 36 and a knob 38. The stud 36 is attached to the retention tube 10 with any suitable fastening process. The knob 38 is threadably received by the stud 36. The stud 36 is inserted through a hole 40 in the pressure lip 34. An end of the pressure lip 34 exerts pressure on the material roll 10 relative to the support surface 32 to prevent the material roll 10 from unrolling.

With reference to FIG. 4, the cleaning material dispenser 1 is attached to a user by securing one side of an attachment clip 42 to the retention tube 10 or tube support end cap 12. The attachment clip 42 is slipped over a belt, pants, a shirt or any other appropriate area of clothing. With reference to FIG. 5, the cleaning material dispenser 1 is attached to a caulking gun 100 with a clamp assembly 44. The clamp assembly 44 preferably includes a U-shaped bracket 45 and a clamping bolt 46. One side of the U-shaped bracket 44 is preferably secured to the tube support end cap 12 of the cleaning material dispenser 1. The U-shaped bracket 44 could also be secured to the retention tube 10. The U-shaped bracket 44 is preferably placed over a top of a trigger assembly 102 of the caulking gun 100 and the clamping bolt 46 is tightened until the clamp assembly 44 is secured to the caulking gun 100. The cleaning material dispenser 1 may also be attached to any other part of the caulking gun 100.

With reference to FIG. 6, the cleaning material dispenser 1 is attached to a caulking gun 104 with an attachment bracket 48. The attachment bracket 48 includes a clamping leg 50 and an attachment leg 52. The attachment leg 52 extends from an end of the clamping leg 50. The attachment leg 52 is preferably curved to receive the outer perimeter of the retention tube 10. The attachment leg 52 is secured to the retention tube 10 with any suitable fastening method. A bolt 54 and a nut 56 are used to attach the clamping leg 50 to a caulking gun 104. The bolt 54 is inserted through a bolt hole (not shown) in the clamping leg 50 and a slot (not shown) preferably in a top of a trigger assembly 106 of the caulking gun 104. The clamping leg 52 is secured to the caulking gun 104 by tightening the nut 56 on the bolt 54. However, other types of brackets or fastening methods may also be used to attach the cleaning material dispenser to the caulking gun 104. The cleaning material dispenser 1 may also be attached to any other part of the caulking gun 104.

With reference to FIG. 7, a cleaning material dispenser 1 may also be formed as an integral part of a trigger assembly 110 of a caulking gun 108. The tube support end cap 12 is preferably rigidly attached to a top of a trigger assembly 110 and the other elements of the cleaning material dispenser assembled to the tube support end cap 12. The tube retention tube 10 could also be rigidly attached to the top of the trigger assembly 110 and the other elements of the cleaning material dispenser assembled in the retention tube 10. Other methods of forming the cleaning material dispenser 1 as an integral portion of the caulking gun 108 may also be used. The cleaning material dispenser 1 may also be formed as an integral portion of other areas of the caulking gun 108, besides the trigger assembly 110, such as in the middle of the caulking tube retainer 112.

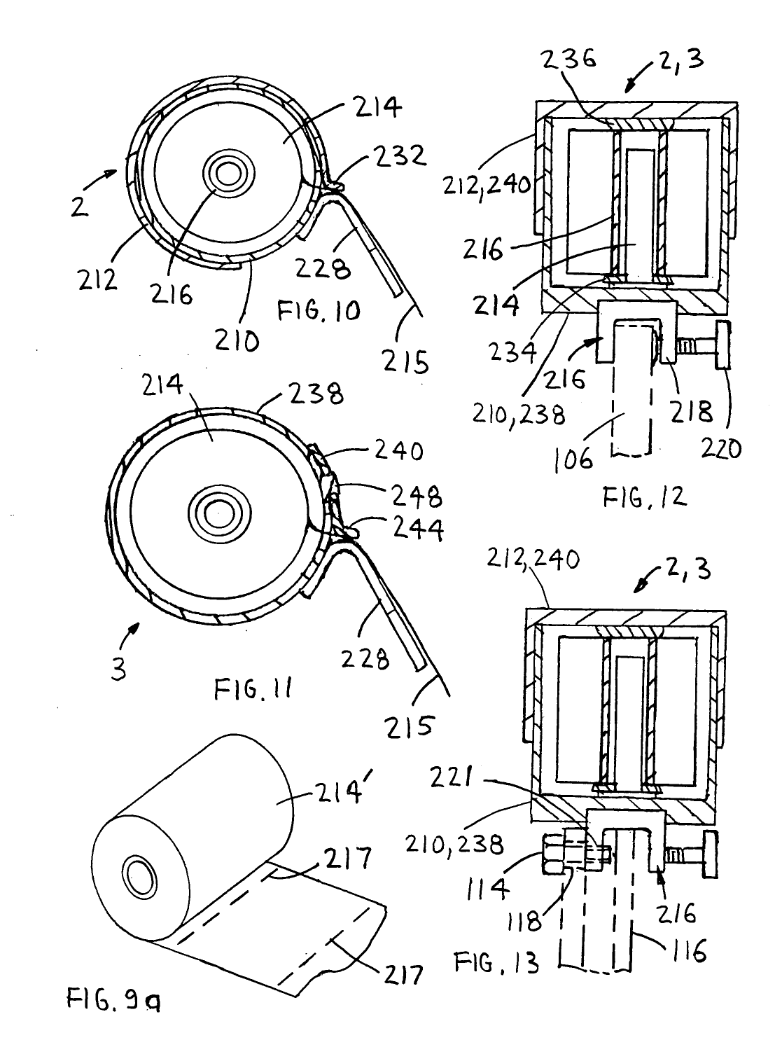

With reference to FIGS. 8, 10, 12 and 13, a second embodiment of a cleaning material dispenser 2 includes a container base 210, container end cap 212, and a material roll 214. An attachment device 216 extends from a bottom of the container base 210. The attachment device 216 preferably includes a U-shaped bracket 218 and a clamping bolt 220. However, other types of attachment devices may also be used. The U-shaped bracket 218 is secured to a top of a trigger assembly 106 with the clamping bolt 220. A threaded fastener 114 may be used to secure the U-shaped bracket 218 to a hollow top of a trigger assembly 116 of a caulking gun. An opening 118 is formed through a side wall of the trigger assembly 116. The threaded fastener 114 is inserted through the opening 118 and threaded into a tapped hole 221 in the U-shaped bracket 218.

An inner perimeter 222 of the container base 210 is sized to receive an outer perimeter of the material roll 214. A material spindle 224 preferably extends from a bottom of an inner perimeter 222 of the container base 210. The material spindle 224 is sized to be received by a spindle tube 216 of the material roll 214. An outer perimeter of the container base 210 is sized to removably receive an inner perimeter of the container end cap 212. A material slot 226 is formed through a wall of the container base 210 to receive an end of the material roll 214. A dispenser support 228 is preferably attached adjacent to the material slot 226 with any suitable process.

A serrated edge 230 is preferably formed on an end of the dispenser support 228 to allow a piece of material to be severed from an end 215 of the material roll 214. With reference to FIG. 9a, a material roll 214′ includes a plurality of periodic separation cut lines 217 (similar to that found in toilet paper), which eliminate or minimize the need to severe a piece of material from the material roll 214′ with the serrated edge 230. A material tab 232 preferably extends from a wall of the container end cap 212. The material tab 232 is used to restrain movement of the piece of material 215 by rotating the container end cap 212, such that the material tab 232 applies force to the piece of material 215. A material clearance area 233 is formed in a portion of a wall of the container end cap 212, adjacent the material 232 to provide clearance for the material slot 226 and the dispenser support 228.

A lower rotation inhibitor 234 is preferably retained on a bottom of the material spindle 224. An upper rotation inhibitor 236 is preferably attached to an inside of the container end cap 212, adjacent an end of the material spindle 224. The rotation inhibitors are fabricated from any appropriate material, such as either a hook fastener or a loop fastener of a hook and loop fastener. The rotation inhibitors prevent the material roll 214 from “free wheeling,” when pulled with too much force.

With reference to FIGS. 9 and 11, a third embodiment of the cleaning material dispenser 3 includes a container base 238, a container end cap 240 and the material roll 214. The attachment device 216 allows the cleaning material dispenser 3 to be secured to the caulking gun. A spring loaded projection 242 is formed in a side wall of the container base 238 by cutting a substantially U-shaped channel 244 through a wall of the container base 238 to form a spring finger 246. A projection 248 extends outward from an end of the spring finger 246. The container base 238 must be fabricated from a material with memory, such that the spring finger 246 returns to its original position, after being pressed downward.

A projection opening 245 is formed through a wall of the container end cap 240 to receive the projection 248. A material clearance area 243 is formed in a wall of the container end cap 240 provide clearance for the material slot 226 and the dispenser support 228. The material area 243 is also preferably formed adjacent the projection opening 245 to allow the wall adjacent the projection opening 245 to flex, slightly. A material tab 244 preferably extends from the wall of the container end cap 240, adjacent the material slot 226.

An inner perimeter 250 of the container base 238 is sized to receive an outer perimeter of the material roll 214. A material spindle 224 preferably extends from a bottom of an inner perimeter 250 of the container base 238. An outer perimeter of the container base 238 is sized to removably receive an inner perimeter of the container end cap 240. A material slot 226 is formed through a wall of the container base 238 to receive an end 215 of the material roll 214. A dispenser support 228 is preferably attached adjacent to the material slot 226 with any suitable process. The dispenser support 228 may also be formed as an integral portion of the cleaning material dispensers 2, 3. Further, the attachment clip 42 may be attached to the container base 210, 238 or the container end cap 212, 240 of the clean material dispenser 2, 3, respectively. The attachment clip 42 may be secured to a belt or to a piece of clothing.

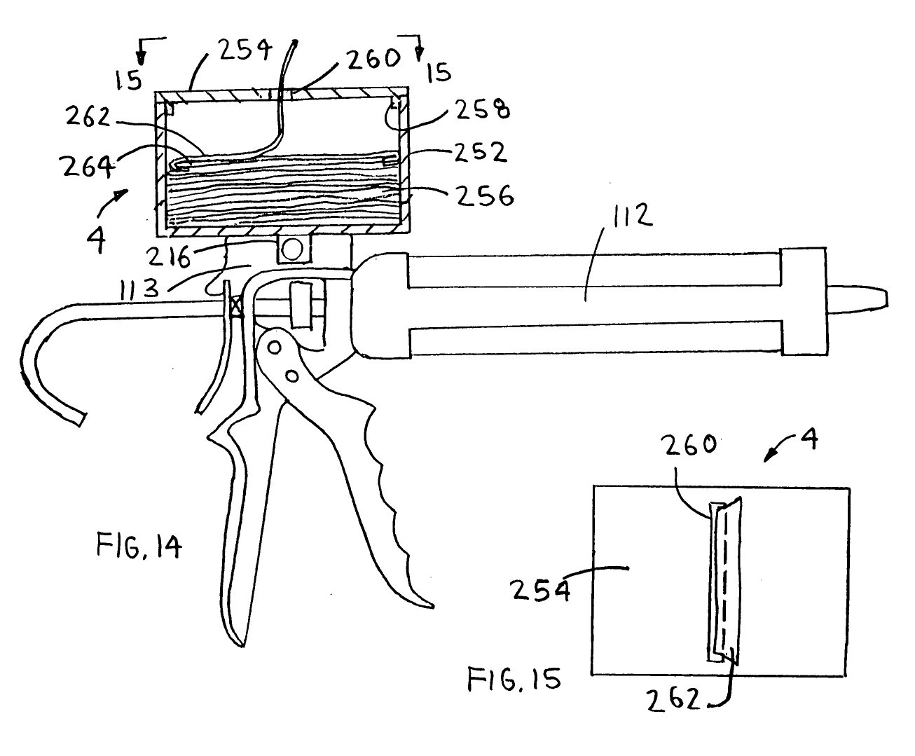

With reference to FIGS. 14-15, a fourth embodiment of a cleaning material dispenser 4 includes a material container 252, a container lid 254 and a quantity of cleaning material 256. A peripheral rim 258 preferably extends from a bottom of the container lid 254. An inside perimeter of the container lid 254 is sized to receive the peripheral rim 258. A material slot 260 is formed through a top of the container lid 254 to receive an end of the quantity of cleaning material 256. The quantity of cleaning material 256 is preferably in the form of a plurality of individual sheets that are connected to each other, such that when a first sheet 262 is pulled out of the cleaning material dispenser 4, a second sheet 264 replaces thereof in the material slot 260. The above method of dispensing cleaning material is well known in the art and does not need further explanation. An attachment device 216 preferably extends from a bottom of the cleaning material dispenser 4 for attachment to a top of a trigger assembly 113 of the caulking gun 112. Further, the attachment clip 42 may be attached to the material container 252. The attachment clip 42 may be secured to a belt or to a piece of clothing.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of cleaning excess caulk from a dispensing tip of a caulking gun, comprising the steps of:
providing a roll of material capable of removing excess caulk;
retaining said roll of material in a dispenser;
separating a single piece of material from said roll; and
attaching said dispenser to a piece of clothing.

2. The method of cleaning excess caulk from a dispensing tip of a caulking gun of claim 1, further comprising the step of:
providing an attachment clip for attaching said dispenser to a piece of clothing.

3. The method of cleaning excess caulk from a dispensing tip of a caulking gun of claim 1, further comprising the step of:
separating said single piece of material from said roll with a shear edge.

4. The method of cleaning excess caulk from a dispensing tip of a caulking gun of claim 1, further comprising the step of:
attaching a dispenser support terminated with a shear edge to said dispenser.

5. The method of cleaning excess caulk from a dispensing tip of a caulking gun of claim 1, further comprising the step of:
fabricating at least one element of said dispenser from a clear or translucent material.

6. The method of cleaning excess caulk from a dispensing tip of a caulking gun of claim 1, further comprising the step of:
providing a roll of material with a plurality of periodic separation cut lines.

7. A method of cleaning excess caulk from a dispensing tip of a caulking gun, comprising the steps of:
providing a roll of material capable of removing excess caulk;
retaining said roll of material in a dispenser;
separating a single piece of material from said roll; and
securing said dispenser to said caulking gun.

8. The method of cleaning excess caulk from a dispensing tip of a caulking gun of claim 7, further comprising the step of:
providing an attachment device for securing said dispenser to a caulking gun.

9. The method of cleaning excess caulk from a dispensing tip of a caulking gun of claim 7, further comprising the step of:
forming said dispenser as an integral portion of a caulking gun.

10. The method of cleaning excess caulk from a dispensing tip of a caulking gun of claim 7, further comprising the step of:
separating said single piece of material from said roll with a shear edge.

11. The method of cleaning excess caulk from a dispensing tip of a caulking gun of claim 7, further comprising the step of:
attaching a dispenser support to said dispenser that is terminated with a shear edge.

12. The method of cleaning excess caulk from a dispensing tip of a caulking gun of claim 7, further comprising the step of:
providing said dispenser with a container base and a container end cap, an open end of said container base being sized to receive said end cap.

13. The method of cleaning excess caulk from a dispensing tip of a caulking gun of claim 7, further comprising the step of:
forming a spring loaded projection on a wall of said container base, forming a projection opening through a wall of said container end cap to receive a projection of said spring loaded projection.

14. The method of cleaning excess caulk from a dispensing tip of a caulking gun of claim 7, further comprising the step of:
extending a material tab from said container end cap adjacent a dispenser support.

15. The method of cleaning excess caulk from a dispensing tip of a caulking gun of claim 7, further comprising the step of:
fabricating at least one element of said dispenser from a clear or translucent material.

16. The method of cleaning excess caulk from a dispensing tip of a caulking gun of claim 7, further comprising the step of:
providing a roll of material with a plurality of periodic separation cut lines.

17. A method of cleaning excess caulk from a dispensing tip of a caulking gun, comprising the steps of:
providing a quantity of cleaning material capable of removing excess caulk;
retaining said quantity of cleaning material in a dispenser, extending an end of said quantity of cleaning material from said dispenser;
forming said quantity of cleaning material of a plurality of sheets, connecting said plurality of sheets to each other such that when a first sheet is pulled out of said dispenser a second sheet replaces thereof; and
securing said dispenser to said caulking gun.

18. The method of cleaning excess caulk from a dispensing tip of a caulking gun of claim 17, further comprising the step of:
fabricating at least one element of said dispenser from a clear or translucent material.

19. The method of cleaning excess caulk from a dispensing tip of a caulking gun of claim 17, further comprising the step of:
providing said dispenser with a material container and a container lid, an open end of said material container being sized to receive said container lid, forming a material slot through a top of said container lid for an end of said quantity of material.
